(19) United States
(12) Patent Application Publication
(10) Pub. No.: US 2019/0346638 A1
(43) Pub. Date: Nov. 14, 2019

(54) OPTICAL MODULE

(71) Applicant: FUJITSU LIMITED, Kawasaki-shi (JP)

(72) Inventor: Mitsuo Suehiro, Kawasaki (JP)

(73) Assignee: FUJITSU LIMITED, Kawasaki-shi (JP)

(21) Appl. No.: 16/372,479

(22) Filed: Apr. 2, 2019

(30) Foreign Application Priority Data
May 9, 2018 (JP) 2018-090699

(51) Int. Cl. G02B 6/42

(52) U.S. Cl. CPC G02B 6/4226; G02B 6/4206

(57) ABSTRACT

An optical module includes a casing, a substrate fixed to a first surface of the casing, the first surface is included in an inside of the casing, an optical element disposed on the substrate and includes at least one of a light receiving element and a light emitting element, a lens block disposed on the inside of the casing, and optically couples an optical connector coupled to an optical transmission line and the optical element to each other, and a male screw disposed so as to pass through a hole disposed in a second surface of the casing, the second surface being opposite from the first surface, and a hole disposed in the lens block, and changes a distance between the second surface and the lens block when the male screw is rotated.

### CROSS-REFERENCE TO RELATED APPLICATION

This application is based upon and claims the benefit of priority of the prior Japanese Patent Application No. 2018-90699, filed on May 9, 2018, the entire contents of which are incorporated herein by reference.

### FIELD

The embodiment discussed herein is related to an optical module.

### BACKGROUND

There is an optical module in which a lens block optically couples optical elements such as light emitting elements and light receiving elements or the like to an optical connector at an end of an optical transmission line. There is also a technology in which a condensing lens unit is fixed on a movable base capable of fine adjustment according to an amount of rotation of an adjusting screw, and optical axis alignment of the condensing lens unit with a semiconductor laser array is performed.

However, there is a problem in that it is difficult to adjust a distance between the optical elements such as the light emitting elements and the light receiving elements or the like and the lens block in the optical module. For example, an index of refraction in a propagation path of light between the optical elements and lenses differs between conditions in which the optical module is used in air and conditions in which the optical module is used in a liquid. Thus, when it is difficult to adjust the distance between the optical elements and the lenses, an optical loss is increased depending on the conditions.

The following is a reference document.

### [Document 1] Japanese Laid-open Patent Publication No. 2004-246158.

### SUMMARY

According to an aspect of the embodiment, an optical module includes a casing, a substrate fixed to a first surface of the casing, the first surface is included in an inside of the casing, an optical element disposed on the substrate and includes at least one of a light receiving element and a light emitting element, a lens block disposed on the inside of the casing, and optically couples an optical connector coupled to an optical transmission line and the optical element to each other, and a male screw disposed so as to pass through a hole disposed in a second surface of the casing, the second surface being opposite from the first surface, and a hole disposed in the lens block, and changes a distance between the second surface and the lens block when the male screw is rotated.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a partially transparent side view illustrating an example of an optical module according to an embodiment;

FIG. 2 is a partially transparent top view illustrating an example of an optical module according to the embodiment;

FIG. 3 is a top view illustrating an example of a PCB of an optical module according to the embodiment;

FIG. 4 is a top view illustrating an example of a lens block of an optical module according to the embodiment;

FIG. 5 is a partially transparent top view illustrating an example of a lens block and an optical connector of an optical module according to the embodiment;

FIG. 6 is a front view illustrating an example of an optical connector of an optical module according to the embodiment;

FIG. 7 is a diagram illustrating an example of an optical system model of an optical module according to the embodiment;

FIG. 8 is a partially transparent side view (1) illustrating an example of a process of manufacturing an optical module according to the embodiment;

FIG. 9 is a partially transparent side view (2) illustrating an example of a process of manufacturing an optical module according to the embodiment;

FIG. 10 is a partially transparent side view (3) illustrating an example of a process of manufacturing an optical module according to the embodiment;

FIG. 11 is a partially transparent side view illustrating an example of a QSFP module to which an optical module according to the embodiment is applied;

FIG. 12 is a diagram illustrating an example of distances in an optical system in each optical transmission environment of an optical module according to the embodiment;

FIG. 13 is a diagram illustrating an example of adjusting scales of a fine thread screw according to the embodiment;

FIG. 14 is a diagram illustrating an example of adjustment of an optical element-to-lens distance of an optical module according to the embodiment;

FIG. 15 is a diagram illustrating another example of adjustment of an optical element-to-lens distance of an optical module according to the embodiment;

FIG. 16 is a diagram illustrating an example of adjustment of an optical connector-to-lens distance of an optical module according to the embodiment;

FIG. 17 is a diagram illustrating another example of adjustment of an optical connector-to-lens distance of an optical module according to the embodiment; and

FIG. 18 is a partially transparent side view illustrating another example of a part of an optical module according to the embodiment.

### DESCRIPTION OF EMBODIMENT

An embodiment of an optical module according to the present technology will hereinafter be described in detail with reference to the drawings.

### Embodiment

### (Part of Optical Module According to Embodiment)

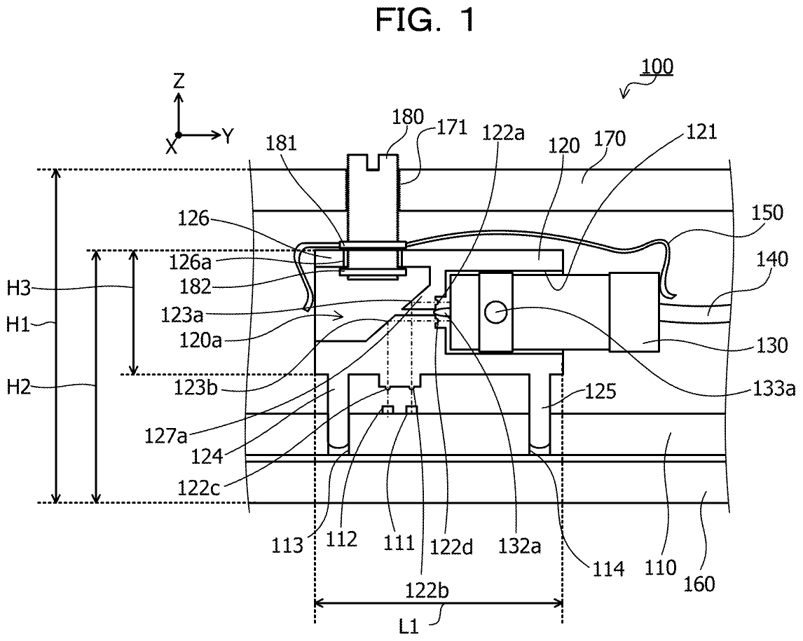

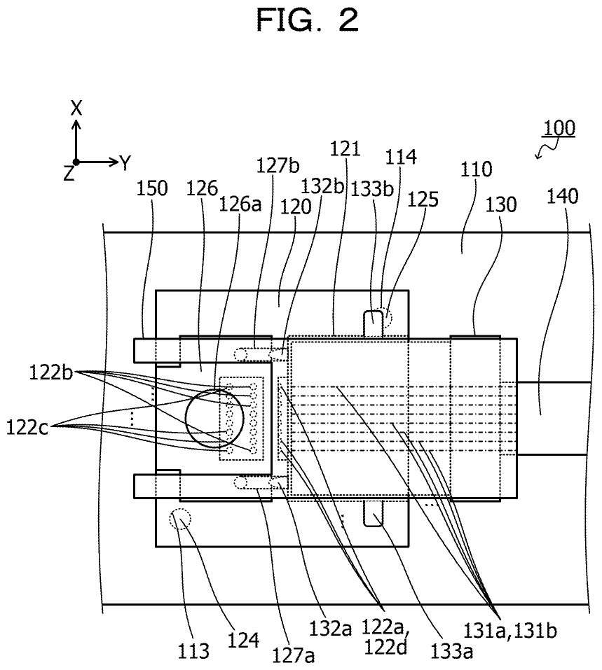

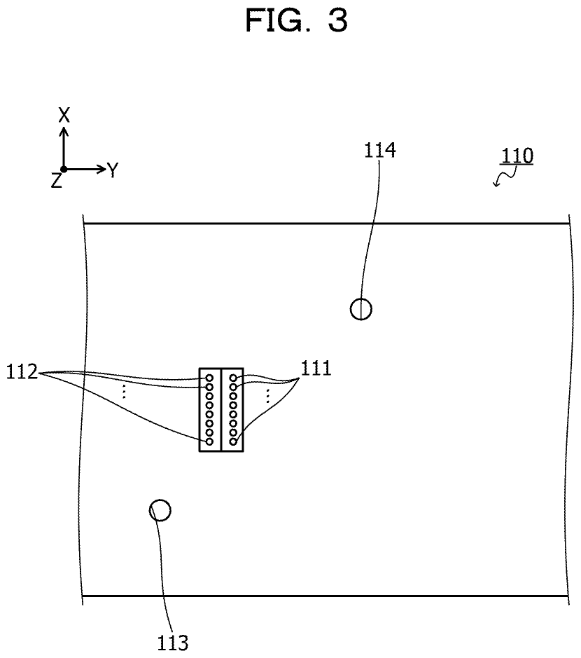

FIG. 1 is a partially transparent side view illustrating an example of an optical module according to an embodiment. FIG. 2 is a partially transparent top view illustrating an example of an optical module according to the embodiment. FIG. 3 is a top view illustrating an example of a PCB of an optical module according to the embodiment.

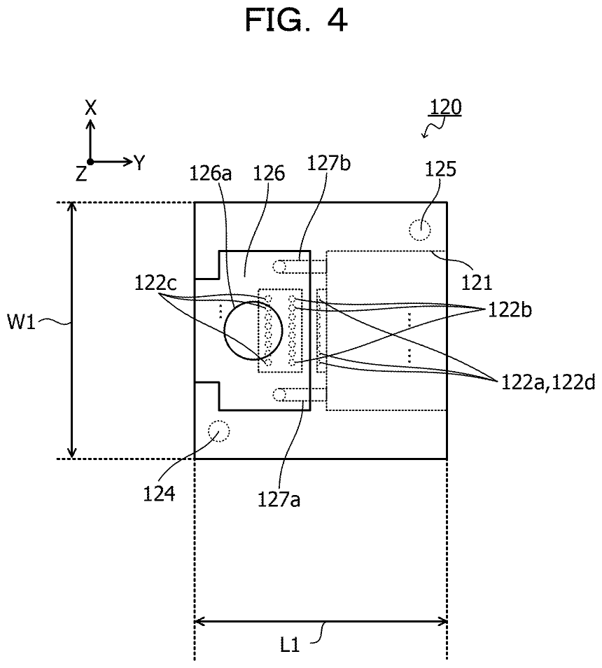

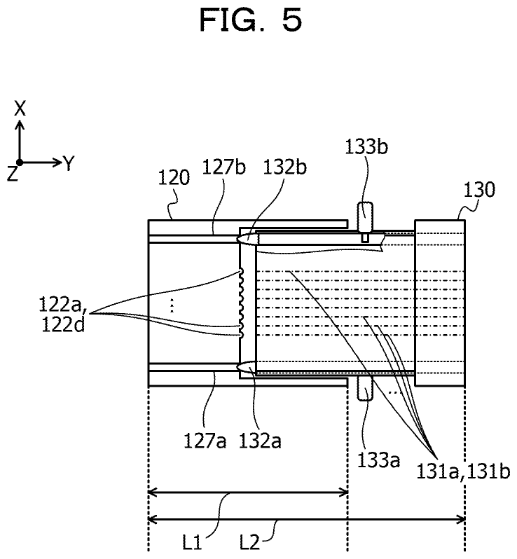

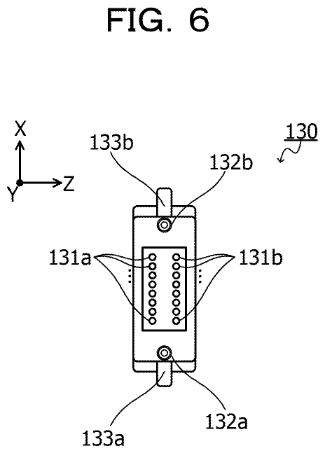

FIG. 4 is a top view illustrating an example of a lens block of an optical module according to the embodiment. FIG. 5 is a partially transparent top view illustrating an example of a lens block and an optical connector of an optical module according to the embodiment. FIG. 6 is a front view illustrating an example of an optical connector of an optical module according to the embodiment.

As illustrated in FIG. 1 and FIG. 2, an optical module 100 according to the embodiment includes a PCB 110, a lens block 120, an optical connector 130, a fiber cable 140, and an MT clip 150. The optical module 100 also includes a lower surface side cover 160, an upper surface side cover 170, and a fine thread screw 180. PCB is an abbreviation of Printed Circuit Board (printed board). MT is an abbreviation of Mechanically Transferable. Incidentally, FIG. 2 illustrates the PCB 110, the lens block 120, the optical connector 130, the fiber cable 140, and the MT clip 150 among these configurations.

Here, a thickness direction (vertical direction in FIG. 1) of the PCB 110 is set as a Z-axis direction. In addition, a traveling direction of light in the optical connector 130 (horizontal direction in FIG. 1) is set as a Y-axis direction. In addition, a direction (depth direction in FIG. 1) orthogonal to the Z-axis direction and the Y-axis direction is set as an X-axis direction.

As illustrated in FIGS. 1 to 3, the PCB 110 is a substrate fixed to the inside of the lower surface side cover 160. A PD array 111 and a VCSEL array 112 are arranged on a top surface of the PCB 110. PD is an abbreviation of Photo Detector. VCSEL is an abbreviation of Vertical Cavity Surface Emitting Laser.

The PD array 111 is a light receiving unit including a plurality of PDs (eight PDs in the example illustrated in FIGS. 1 to 3) arranged in a one-dimensional manner in the X-axis direction. The PDs of the PD array 111 are, respectively, light receiving elements that receive respective pieces of light emitted from the lens block 120. The VCSEL array 112 is a light emitting unit including a plurality of LDs (eight LDs in the example illustrated in FIGS. 1 to 3) arranged in a one-dimensional manner in the X-axis direction. The LDs of the VCSEL array 112 are light emitting elements that generate respective pieces of light, and emit the generated respective pieces of light to the lens block 120.

In addition, the PCB 110 is provided with guide holes 113 and 114. The guide holes 113 and 114 are holes respectively arranged at different positions of the PCB 110 and penetrating the PCB 110 in the Z-axis direction. For example, each of the guide holes 113 and 114 is a cylindrical hole. However, each of the guide holes 113 and 114 may be a cylindrical shape, and besides, may be holes of various shapes including polygonal prisms such as a triangular prism, a quadrangular prism, and the like. In addition, the guide holes 113 and 114 do not need to penetrate to the undersurface of the PCB 110 as long as the guide holes 113 and 114 are opened on the top surface side of the PCB 110. In addition, the number of guide holes may be two as in the case of the guide holes 113 and 114, and besides, may be three or more, or may be one in the case of a hole in the shape of a polygonal prism such as a triangular prism, a quadrangular prism, or the like.

As illustrated in FIG. 1, FIG. 2, and FIG. 4, the lens block 120 is an optical system that optically couples the PD array 111 and the VCSEL array 112 to the optical connector 130. For example, the lens block 120 emits each piece of light emitted from the optical connector 130 in the Y-axis direction to the PD array 111 in the Z-axis direction, and emits each piece of light emitted from the VCSEL array 112 in the Z-axis direction to the optical connector 130 in the Y-axis direction. The lens block 120 is formed by a polyimide-based transparent resin as an example. However, the lens block 120 may be formed by a polyimide-based transparent resin, and besides, may be formed by various kinds of transparent materials such as glass and the like.

The lens block 120, for example, includes an opening portion 121, lens unit arrays 122a to 122d, reflecting portions 123a and 123b, guide pins 124 and 125, a ceiling portion 126, and holes 127a and 127b. The opening portion 121 is opened in the Y-axis direction. A front end of the optical connector 130 is housed in the opening portion 121.

The lens unit array 122a is a plurality of lens units (eight lens units in the example illustrated in FIG. 1, FIG. 2, and FIG. 4) arranged in a one-dimensional manner in the X-axis direction. The lens units of the lens unit array 122a respectively collimate respective pieces of light diffused and emitted from the optical connector 130, and emit the collimated respective pieces of light to the reflecting portion 123a. The lens unit array 122b is a plurality of lens units (eight lens units in the example illustrated in FIG. 1, FIG. 2, and FIG. 4) arranged in a one-dimensional manner in the X-axis direction. The lens units of the lens unit array 122b respectively condense the respective pieces of light emitted from the reflecting portion 123a, and emit the condensed respective pieces of light to the PD array 111.

The lens unit array 122c is a plurality of lens units (eight lens units in the example illustrated in FIG. 1, FIG. 2, and FIG. 4) arranged in a one-dimensional manner in the X-axis direction. The lens units of the lens unit array 122c respectively collimate respective pieces of light diffused and emitted from the VCSEL array 112, and emit the collimated respective pieces of light to the reflecting portion 123b. The lens unit array 122d is a plurality of lens units (eight lens units in the example illustrated in FIG. 1, FIG. 2, and FIG. 4) arranged in a one-dimensional manner in the X-axis direction. The lens units of the lens unit array 122d condense the respective pieces of light emitted from the reflecting portion 123b, and emit the condensed respective pieces of light to the optical connector 130.

The reflecting portion 123a reflects each piece of light emitted from the lens unit array 122a at an angle of 90 degrees, and emits the light to the lens unit array 122b. The reflecting portion 123b reflects each piece of light emitted from the lens unit array 122c at an angle of 90 degrees, and emits the light to the lens unit array 122d. The reflecting portions 123a and 123b are, for example, realized by a space 120a provided in the lens block 120. For example, due to different indexes of refraction of the lens block 120 and the space 120a, boundary surfaces between the lens block 120 and the space 120a constitute the reflecting portions 123a and 123b.

The guide pins 124 and 125 are projections having shapes corresponding to the guide holes 113 and 114, respectively. The guide pins 124 and 125 are inserted into the guide holes 113 and 114, respectively. The relative position of the lens block 120 on an XY plane with respect to the PCB 110 is fixed by inserting the guide pins 124 and 125 into the guide holes 113 and 114, respectively. In addition, the relative position of the lens block 120 in the Z-axis direction with respect to the PCB 110 is variable because the guide pins 124 and 125 are not fixed in the Z-axis direction with respect to the guide holes 113 and 114, respectively.

The ceiling portion 126 is a part over the space 120a in the lens block 120. The ceiling portion 126 includes a through hole 126a. The through hole 126a is a hole penetrating the ceiling portion 126 in the Z-axis direction. For example, the through hole 126a is a circular hole having a diameter equal to or more than the diameter of the fine thread screw 180 and less than the diameter of E-rings 181 and 182.

The holes 127a and 127b are holes in the Y-axis direction, the holes being arranged in a bottom surface of the opening portion 121 of the lens block 120. The holes 127a and 127b, for example, penetrate from the bottom surface of the opening portion 121 of the lens block 120 to the space 120a. Respective front ends of pins 132a and 132b of the optical connector 130 to be described later are respectively inserted into respective opening portions in the holes 127a and 127b, the opening portions being on the side of the optical connector 130.

As illustrated in FIG. 1, FIG. 2, FIG. 5, and FIG. 6, the optical connector 130 is a connector provided to one end of the fiber cable 140. The fiber cable 140 may be optically coupled to the lens block 120 by housing the optical connector 130 in the opening portion 121 of the lens block 120. In addition, the optical connector 130 is fixed by the MT clip 150 in a state in which the front end of the optical connector 130 is housed in the opening portion of the lens block 120. For example, the optical connector 130 is fixed in a state of being biased to the bottom surface side of the opening portion 121 of the lens block 120 (left side in FIG. 1) by the MT clip 150.

The optical connector 130 includes optical waveguide arrays 131a and 131b, pins 132a and 132b, and adjusting handles 133a and 133b. The optical waveguide array 131a emits each piece of light passed through the fiber cable 140 to the lens unit array 122a of the lens block 120. The optical waveguide array 131b emits each piece of light emitted from the lens unit array 122d of the lens block 120 to the fiber cable 140.

Front ends of the respective pins 132a and 132b project toward the lens block 120 from an end surface of the optical connector 130, the end surface being on the side of the lens block 120 (left side in FIG. 1). In addition, the pins 132a and 132b have a tapered shape whose diameter is decreased toward the front ends thereof. Alignment between the lens unit arrays 122a and 122d and end portions of the optical waveguide arrays 131a and 131b on an XZ plane may be performed by respectively inserting the front ends of the pins 132a and 132b into the holes 127a and 127b of the lens block 120.

In addition, parts of the pins 132a and 132b excluding the front ends thereof are male screws, and screw grooves corresponding to the pins 132a and 132b are provided to regions housing the pins 132a and 132b in a main body of the optical connector 130. Hence, each of the pins 132a and 132b is changed in relative position in the Y-axis direction with respect to the main body of the optical connector 130 by being rotated about an axis in the Y-axis direction.

The adjusting handles 133a and 133b are adjusting parts that change a distance between the optical connector 130 and the lens block 120 by adjusting amounts of projection of the pins 132a and 132b from the end surface of the optical connector 130. Each of the adjusting handles 133a and 133b is, for example, rotatable about the Y-axis direction.

When the adjusting handle 133a is rotated, the pin 132a is rotated about the axis in the Y-axis direction to change the amount of projection of the pin 132a to the side of the lens block 120. Similarly, when the adjusting handle 133b is rotated, the pin 132b is rotated about the axis in the Y-axis direction to change the amount of projection of the pin 132b to the side of the lens block 120.

Increasing the amounts of projection of the pins 132a and 132b lengthens a distance in the Y-axis direction between the lens unit arrays 122a and 122d of the lens block 120 and end portions of the optical waveguide arrays 131a and 131b of the optical connector 130. In addition, as described above, the MT clip 150 biases the optical connector 130 to the side of the lens block 120. Therefore, decreasing the amounts of projection of the pins 132a and 132b shortens the distance in the Y-axis direction between the lens unit arrays 122a and 122d of the lens block 120 and the end portions of the optical waveguide arrays 131a and 131b of the optical connector 130.

For example, the rotation of the adjusting handles 133a and 133b may adjust the distance in the Y-axis direction between the lens unit arrays 122a and 122d of the lens block 120 and the end portions of the optical waveguide arrays 131a and 131b of the optical connector 130. Hereinafter, the distance in the Y-axis direction between the lens unit arrays 122a and 122d of the lens block 120 and the end portions of the optical waveguide arrays 131a and 131b of the optical connector 130 will be referred to as an “optical connector-to-lens distance.” A direction of adjustment of the optical connector-to-lens distance is determined according to a direction of rotation of the adjusting handles 133a and 133b.

As illustrated in FIG. 1 and FIG. 2, the fiber cable 140 is an optical transmission line that passes each piece of light transmitted from an opposite device of the optical module 100, and emits the light to the optical connector 130. In addition, the fiber cable 140 emits each piece of light emitted from the optical connector 130 toward the opposite device of the optical module 100. The MT clip 150 is an implement that fixes the optical connector 130 in a state of being housed in the opening portion 121 of the lens block 120, as described above.

As illustrated in FIG. 1, the lower surface side cover 160 is a cover on the lower surface side of the optical module 100 (lower side in FIG. 1). The upper surface side cover 170 is a cover on an opposite side from the lower surface side cover 160, for example, a cover on the upper surface side of the optical module 100 (upper side in FIG. 1). In addition, the upper surface side cover 170 is fixed to the lower surface side cover 160.

A casing of the optical module 100 is realized by the lower surface side cover 160 and the upper surface side cover 170. The lower surface side cover 160 and the upper surface side cover 170 may, for example, be realized by a metal, a resin, or the like. In addition, the upper surface side cover 170 includes a through hole 171. The through hole 171 penetrates the upper surface side cover 170 in the Z-axis direction. The through hole 171 includes a screw groove on the inside thereof, the screw groove corresponding to a screw groove of the fine thread screw 180 to be described later.

As illustrated in FIG. 1, the fine thread screw 180 is provided so as to pass through (penetrate) the through hole 171 of the upper surface side cover 170 and the through hole 126a of the ceiling portion 126 of the lens block 120. For example, the fine thread screw 180 is inserted in both of the through holes 126a and 171. In addition, the fine thread screw 180 is a male screw including a screw groove on an external surface thereof, the screw groove corresponding to the screw groove on the inside of the through hole 171. The screw groove of the fine thread screw 180 and the screw groove of the through hole 171 mesh with each other. Thus, when the fine thread screw 180 is rotated about the Z-axis direction, the relative position of the fine thread screw 180 with respect to the upper surface side cover 170 is changed in the Z-axis direction.

In addition, two grooves parallel with the XY plane are formed at different positions in the Z-axis direction in a side surface of the fine thread screw 180. The grooves at the two positions are respectively provided with E-rings 181 and 182 parallel with the XY plane. The E-rings 181 and 182 are retaining rings having a diameter larger than the through hole 126a of the ceiling portion 126. The E-rings 181 and 182 sandwich the periphery of the through hole 126a in the ceiling portion 126 in the Z-axis direction. The relative position of the fine thread screw 180 in the Z-axis direction with respect to the lens block 120 is therefore fixed. On the other hand, the fine thread screw 180 has a diameter equal to or less than the diameter of the through hole 126a, and is thus freely rotatable about the Z-axis direction with respect to the through hole 126a.

For example, when the fine thread screw 180 is rotated about the Z-axis direction, the relative position of the fine thread screw 180 with respect to the upper surface side cover 170 is changed in the Z-axis direction, but the relative position of the fine thread screw 180 with respect to the lens block 120 is not changed. It is thereby possible to change the relative position of the lens block 120 in the Z-axis direction with respect to the upper surface side cover 170.

In addition, as described above, the upper surface side cover 170 is fixed to the lower surface side cover 160, and the PCB 110 is fixed to the lower surface side cover 160. In addition, as described above, the relative position of the lens block 120 in the Z-axis direction with respect to the PCB 110 is variable.

Hence, when the fine thread screw 180 is rotated about the Z-axis direction, a relative position in the Z-axis direction between the PCB 110 and the lens block 120 may be adjusted. It is thereby possible to adjust a distance between the PD array 111 and the lens unit array 122b and a distance between the VCSEL array 112 and the lens unit array 122c. Hereinafter, the distances in the Z-axis direction between the PD array 111 and the VCSEL array 112 and the lens unit arrays 122b and 122c of the lens block 120 will be referred to as an “optical element-to-lens distance.”

As an example, an M2 fine thread screw having a screw groove pitch of 0.2 [mm] may be used as the fine thread screw 180 so that the distance between the VCSEL array 112 and the lens unit array 122c may be adjusted in units of 100 [μm]. However, the fine thread screw 180 may use an M2 fine thread screw, and besides, various kinds of screws may be used as the fine thread screw 180.

Description will be made of an example of dimensions of parts of the optical module 100. As illustrated in FIG. 1, a distance H1 between the undersurface of the lower surface side cover 160 and the top surface of the upper surface side cover 170 may be set at 8.5 [mm], for example. A distance H2 between the top surface of the PCB 110 and the upper surface of the lens block 120 may be set at 5.3 [mm], for example. A distance H3 between the lower surface of the part of the lens block 120 excluding the lens unit arrays 122b and 122c and the upper surface of the lens block 120 may be set at 4.0 [mm], for example.

In addition, as illustrated in FIG. 1, FIG. 4, and FIG. 5, a length L1 of the lens block 120 in the Y-axis direction may be set at 6.0 [mm], for example. In addition, as illustrated in FIG. 4, a length W1 of the lens block 120 in the X-axis direction may be set at 8.0 [mm], for example. In addition, as illustrated in FIG. 5, a length L2 in the Y-axis direction of a structure formed by combining the lens block 120 and the optical connector 130 with each other in a state in which the optical connector 130 is housed in the lens block 120 may be set at 12.0 [mm], for example.

(Optical System Model of Optical Module According to Embodiment)

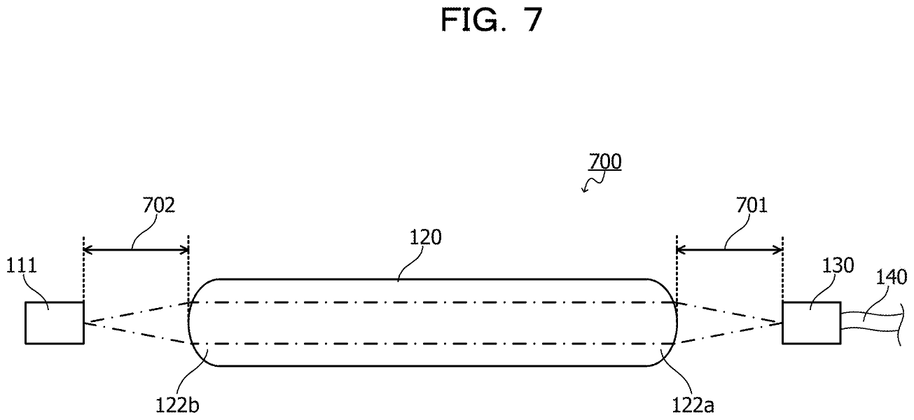

FIG. 7 is a diagram illustrating an example of an optical system model of an optical module according to the embodiment. In FIG. 7, parts similar to the parts illustrated in FIGS. 1 to 6 are identified by the same reference numerals, and description thereof will be omitted. An optical system model 700 illustrated in FIG. 7 is an optical system model on a light receiving side of the optical module 100. The optical system model 700 includes the PD array 111, the lens block 120, and the optical connector 130.

An optical connector-to-lens distance 701 is a distance between the end portion of the optical connector 130 (the optical waveguide array 131a of the optical connector 130) and the lens unit array 122a of the lens block 120. The optical connector-to-lens distance 701 may be adjusted by rotating the above-described adjusting handles 133a and 133b. An optical element-to-lens distance 702 is a distance between the PD array 111 and the lens unit array 122b of the lens block 120. The optical element-to-lens distance 702 may be adjusted by rotating the above-described fine thread screw 180.

As described above, the lens unit array 122a collimates the light emitted from the optical connector 130. In addition, the lens unit array 122b condenses the light passed through the lens block 120 onto the PD array 111. Hence, light receiving efficiency in the PD array 111 may be improved by adjusting the optical connector-to-lens distance 701 and the optical element-to-lens distance 702 such that a light receiving surface of the PD array 111 is located at a condensing position (focus) of the lens unit array 122b.

Description has been made of the optical system model 700 on the light receiving side in the optical module 100. However, similar description also applies to an optical system model on a light emitting side in the optical module 100, for example, the VCSEL array 112, the lens unit arrays 122c and 122d, and the optical connector 130.

(Process of Manufacturing Optical Module According to Embodiment)

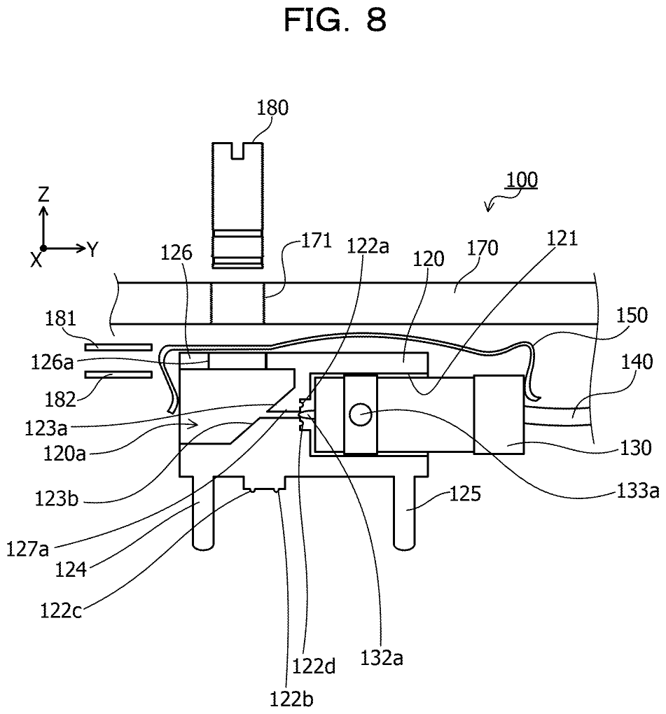

FIGS. 8 to 10 are partially transparent side views illustrating an example of a process of manufacturing an optical module according to the embodiment. In FIGS. 8 to 10, parts similar to the parts illustrated in FIGS. 1 to 6 are identified by the same reference numerals, and description thereof will be omitted. First, as illustrated in FIG. 8, the optical connector 130 is inserted into the opening portion 121 of the lens block 120, and the lens block 120 and the optical connector 130 are fixed to each other by the MT clip 150.

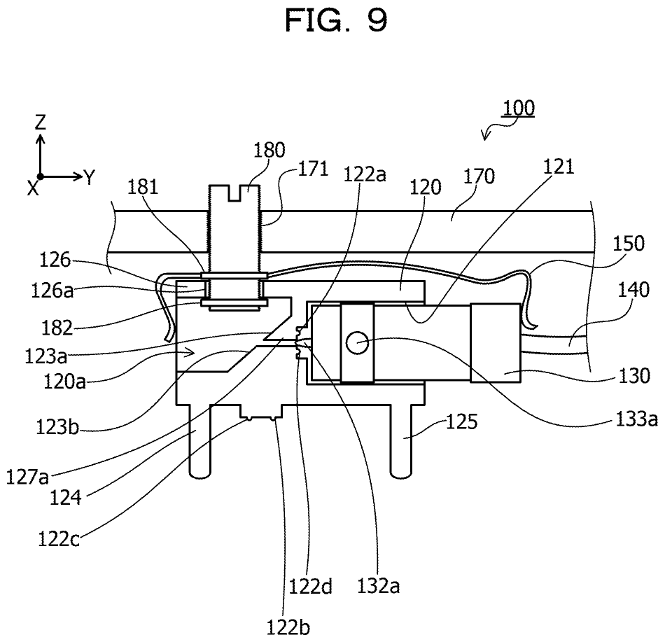

Next, as illustrated in FIG. 9, the fine thread screw 180 is inserted into the through hole 171 of the upper surface side cover 170 and the through hole 126a of the ceiling portion 126 of the lens block 120. At this time, adjustment is made such that the ceiling portion 126 is located between the above-described two grooves of the fine thread screw 180 in the Z-axis direction. Next, the periphery of the through hole 126a in the ceiling portion 126 is sandwiched by the E-rings 181 and 182 in the Z-axis direction by respectively providing the E-rings 181 and 182 to the two grooves of the fine thread screw 180.

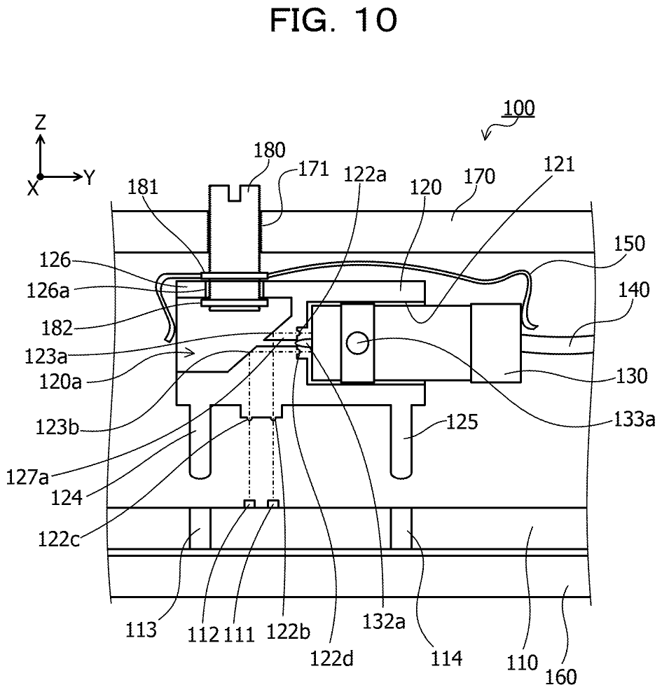

Next, as illustrated in FIG. 10, the guide pins 124 and 125 of the lens block 120 are respectively aligned with the guide holes 113 and 114 of the PCB 110 on the XY plane. Then, the guide pins 124 and 125 of the lens block 120 are respectively inserted into the guide holes 113 and 114 of the PCB 110, and the lower surface side cover 160 and the upper surface side cover 170 are fixed to each other by fastening a screw or the like. The optical module 100 illustrated in FIGS. 1 to 6 may be thereby manufactured. Thereafter, the optical connector-to-lens distance and the optical element-to-lens distance described above may be adjusted by operating the adjusting handles 133a and 133b and the fine thread screw 180.

(QSFP Module to which Optical Module According to Embodiment is Applied)

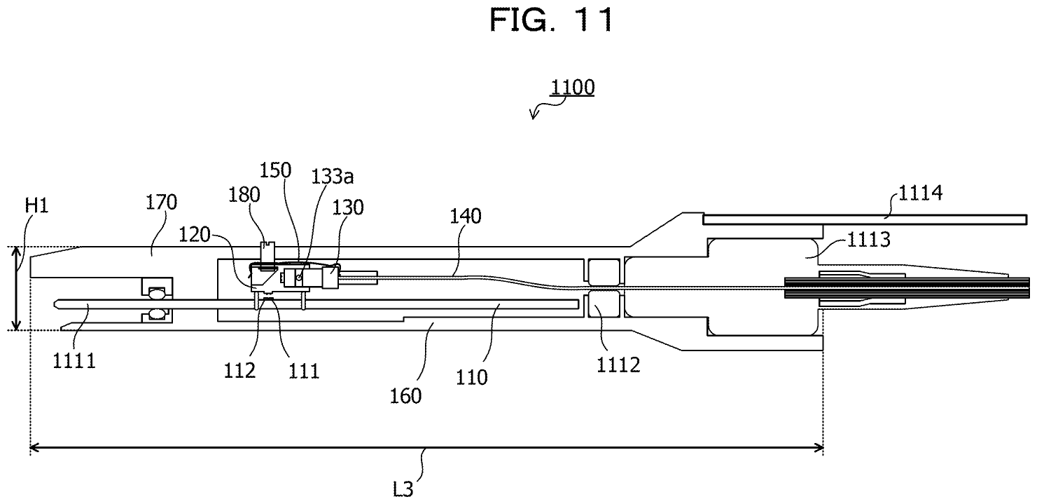

FIG. 11 is a partially transparent side view illustrating an example of a QSFP module to which an optical module according to the embodiment is applied. In FIG. 11, parts similar to the parts illustrated in FIGS. 1 to 6 are identified by the same reference numerals, and description thereof will be omitted. A QSFP module 1100 illustrated in FIG. 11 is a QSFP module to which the above-described optical module 100 is applied. QSFP is an abbreviation of Quad Small Form-factor Pluggable.

The QSFP module 1100 includes each configuration of the optical module 100 illustrated in FIGS. 1 to 6, a terminal 1111, a buffer 1112, a mold 1113, and a tag 1114. The terminal 1111 is a terminal for coupling a circuit on the PCB 110 to another electronic apparatus.

The buffer 1112 and the mold 1113 fix and retain the fiber cable 140 between the lower surface side cover 160 and the upper surface side cover 170. The tag 1114 is an operating part for operating a coupling lock between the QSFP module 1100 and the other electronic apparatus. The QSFP module 1100 may be removed from the other electronic apparatus by releasing the lock by the tag 1114.

In the QSFP module 1100, the fine thread screw 180 is exposed from the upper surface side cover 170 of the QSFP module 1100. In addition, the adjusting handles 133a and 133b are respectively exposed from both side surfaces, not illustrated, of the QSFP module 1100. Hence, the optical connector-to-lens distance and the optical element-to-lens distance described above may be adjusted by operating the fine thread screw 180 and the adjusting handles 133a and 133b after assembly of the QSFP module 1100.

Description will be made of an example of dimensions of parts of the QSFP module 1100. A length L3 in the Y-axis direction of a part of the QSFP module 1100 excluding the tag 1114 may be set at 73 [mm], for example. In addition, a distance H1 between the undersurface of the lower surface side cover 160 and the top surface of the upper surface side cover 170 in the QSFP module 1100 may be set at 8.5 [mm], for example, as in the optical module 100 illustrated in FIG. 1.

However, the configuration and dimensions of the QSFP module 1100 may be those of the example illustrated in FIG. 11, and besides, may be susceptible of various changes. In addition, the optical module 100 may be applied to the QSFP module 1100, and besides, may be applied to various kinds of optical modules.

(Distances in Optical System in Each Optical Transmission Environment of Optical Module According to Embodiment)

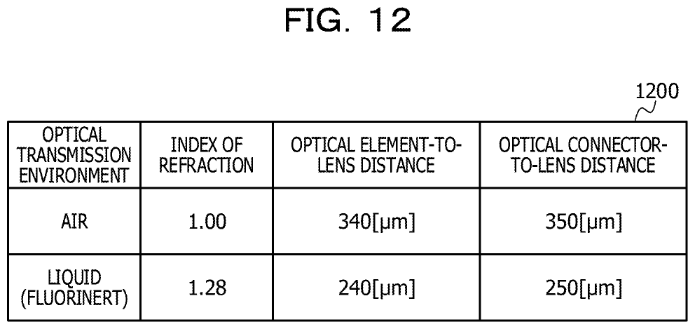

FIG. 12 is a diagram illustrating an example of distances in an optical system in each optical transmission environment of an optical module according to the embodiment. The optical module 100 may be adjusted according to a table 1200 illustrated in FIG. 12, for example. The table 1200 illustrates a combination of an index of refraction with the optical element-to-lens distance and the optical connector-to-lens distance that minimize an optical loss for each environment (optical transmission environment) in which the optical module 100 is installed and the optical module 100 performs optical transmission.

In a case where the optical transmission environment is air, for example, an index of refraction between the PD array 111 and the VCSEL array 112 and the lens unit arrays 122b and 122c and between the optical connector 130 and the lens unit arrays 122a and 122d is 1.00. In this case, as illustrated in the table 1200, an optical loss is minimized by setting the optical element-to-lens distance at 340 [μm], and setting the optical connector-to-lens distance at 350 [μm].

In addition, in a case where the optical transmission environment is a liquid such as Fluorinert or the like, the index of refraction between the PD array 111 and the VCSEL array 112 and the lens unit arrays 122b and 122c and between the optical connector 130 and the lens unit arrays 122a and 122d is 1.28. In this case, the optical loss is minimized by setting the optical element-to-lens distance at 240 [μm], and setting the optical connector-to-lens distance at 250 [μm].

For example, because a liquid such as Fluorinert or the like has a higher index of refraction than air, in the case where the optical transmission environment of the optical module 100 is a liquid such as Fluorinert or the like, the distances in the optical system which distances minimize the optical loss are shorter than in the case where the optical transmission environment of the optical module 100 is air. In the example illustrated in FIG. 12, in the case where the optical transmission environment is a liquid such as Fluorinert or the like, the optical element-to-lens distance and the optical connector-to-lens distance that minimize the optical loss are each shorter by 100 [μm] than in the case where the optical transmission environment is air.

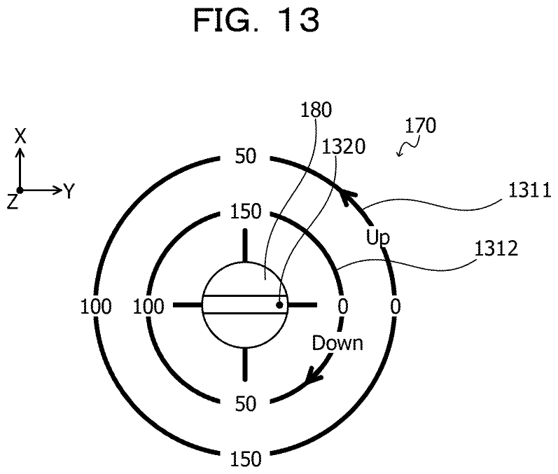

(Adjusting Scales of Fine Thread Screw according to Embodiment) FIG. 13 is a diagram illustrating an example of adjusting scales of a fine thread screw according to the embodiment. Adjusting scales 1311 and 1312, for example, are inscribed on the periphery of the fine thread screw 180 in the upper surface (top surface) of the upper surface side cover 170 of the optical module 100. In addition, on the upper surface of the fine thread screw 180, a mark 1320 is inscribed at a position different from the center of the upper surface of the fine thread screw 180. Suppose, for example, that in an initial state, as illustrated in FIG. 13, the mark 1320 indicates “0” on the adjusting scales 1311 and 1312.

The adjusting scale 1311 indicates a rotational direction and rotation amounts of the fine thread screw 180 for lengthening the optical element-to-lens distance (Up) by bringing the lens block 120 closer to the upper surface side cover 170. The adjusting scale 1312 indicates a rotational direction and rotation amounts of the fine thread screw 180 for shortening the optical element-to-lens distance (Down) by separating the lens block 120 from the upper surface side cover 170.

For example, the adjusting scale 1311 indicates that the optical element-to-lens distance is increased by 50 [μm] each time the fine thread screw 180 is rotated by 90 degrees counterclockwise as viewed from the upper surface side. The adjusting scale 1312 indicates that the optical element-to-lens distance is decreased by 50 [μm] each time the fine thread screw 180 is rotated by 90 degrees clockwise as viewed from the upper surface side.

(Adjustment of Optical Element-to-Lens Distance of Optical Module According to Embodiment)

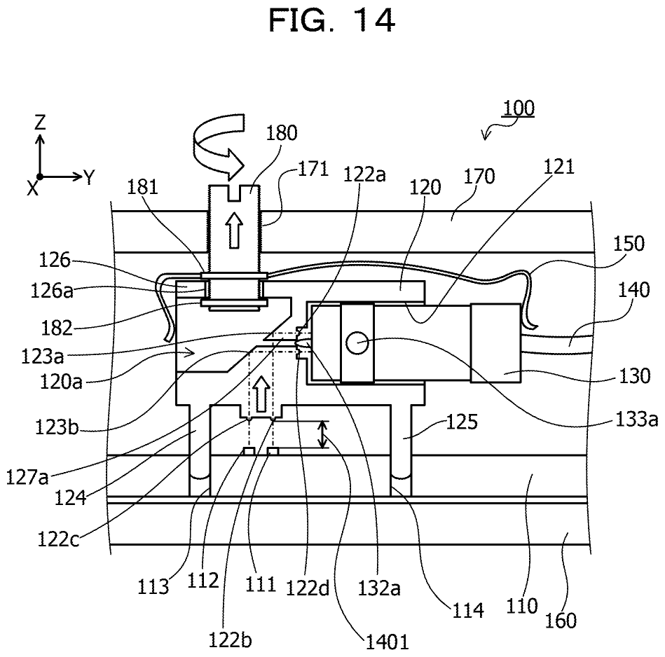

FIG. 14 is a diagram illustrating an example of adjustment of an optical element-to-lens distance of an optical module according to the embodiment. In FIG. 14, parts similar to the parts illustrated in FIG. 1 are identified by the same reference numerals, and description thereof will be omitted. An optical element-to-lens distance 1401 illustrated in FIG. 14 is the distance in the Z-axis direction between the PD array 111 and the VCSEL array 112 and the lens unit arrays 122b and 122c of the lens block 120.

Suppose that in an initial state, the mark 1320 illustrated in FIG. 13 indicates “0” on the adjusting scales 1311 and 1312, and that the optical element-to-lens distance 1401 at this time is 290 [μm]. Then, suppose that the optical transmission environment of the optical module 100 is air.

The optimum optical element-to-lens distance 1401 in the case where the optical transmission environment is air is 340 [μm] (see FIG. 12). An adjusting person therefore rotates the fine thread screw 180 by 90 degrees counterclockwise as viewed from the upper surface side. Consequently, the lens block 120 comes closer to the upper surface side cover 170, and the optical element-to-lens distance 1401 is increased by 50 [μm] (see FIG. 13). The optical element-to-lens distance 1401 may therefore be set at 340 [μm].

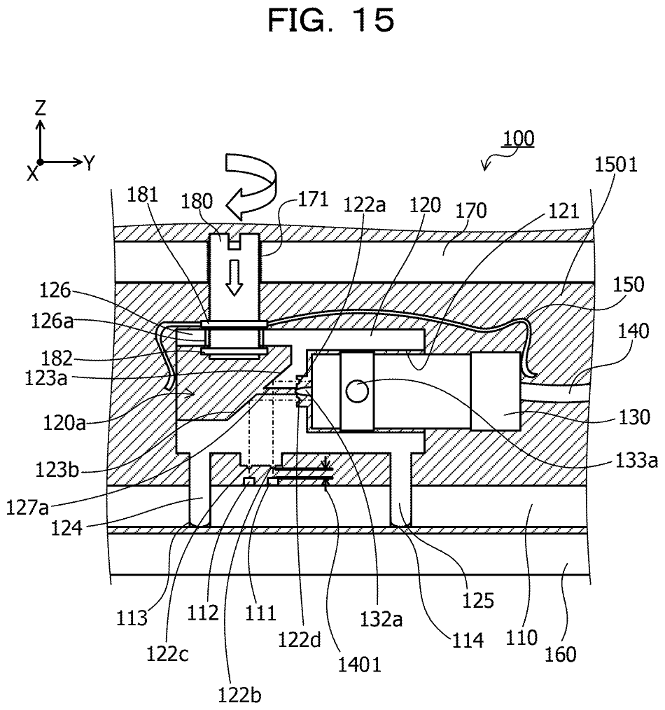

FIG. 15 is a diagram illustrating another example of adjustment of an optical element-to-lens distance of an optical module according to the embodiment. In FIG. 15, parts similar to the parts illustrated in FIG. 1 and FIG. 14 are identified by the same reference numerals, and description thereof will be omitted. Suppose that in an initial state, the mark 1320 illustrated in FIG. 13 indicates “0” on the adjusting scales 1311 and 1312, and that the optical element-to-lens distance 1401 at this time is 290 [μm]. Then, suppose that, as illustrated in FIG. 15, the optical module 100 is immersed in a liquid 1501 for cooling such as Fluorinert or the like, for example, the optical transmission environment of the optical module 100 is a liquid.

The optimum optical element-to-lens distance 1401 in the case where the optical transmission environment is the liquid is 240 [μm] (see FIG. 12). The adjusting person therefore rotates the fine thread screw 180 by 90 degrees clockwise as viewed from the upper surface side. Consequently, the lens block 120 is separated from the upper surface side cover 170, and the optical element-to-lens distance 1401 is decreased by 50 [μm] (see FIG. 13). The optical element-to-lens distance 1401 may therefore be set at 240 [μm].

(Adjustment of Optical Connector-to-Lens Distance of Optical Module According to Embodiment)

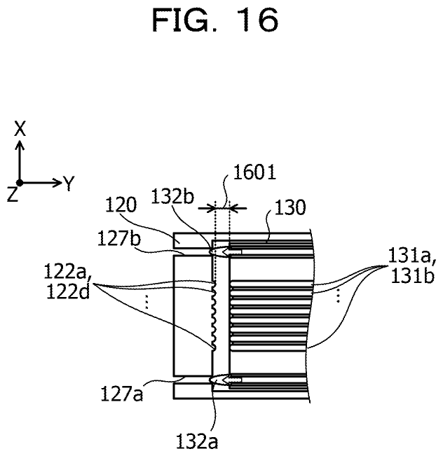

FIG. 16 is a diagram illustrating an example of adjustment of an optical connector-to-lens distance of an optical module according to the embodiment. In FIG. 16, parts similar to the parts illustrated in FIG. 5 are identified by the same reference numerals, and description thereof will be omitted. An optical connector-to-lens distance 1601 illustrated in FIG. 16 is the distance in the Y-axis direction between the lens unit arrays 122a and 122d of the lens block 120 and the end portions of the optical waveguide arrays 131a and 131b of the optical connector 130. Suppose that in an initial state, the optical connector-to-lens distance 1601 is 300 [μm]. Then, suppose that the optical transmission environment of the optical module 100 is air.

The optimum optical connector-to-lens distance 1601 in the case where the optical transmission environment is air is 350 [μm] (see FIG. 12). The adjusting person therefore increases amounts of projection of the pins 132a and 132b by rotating the adjusting handles 133a and 133b. Consequently, the optical connector-to-lens distance 1601 is increased by 50 [μm], so that the optical connector-to-lens distance 1601 may be set at 350 [μm].

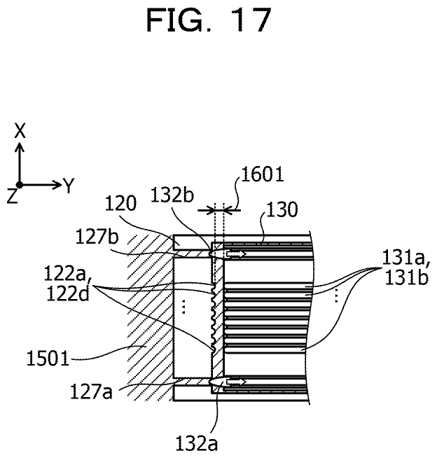

FIG. 17 is a diagram illustrating another example of adjustment of an optical connector-to-lens distance of an optical module according to the embodiment. In FIG. 17, parts similar to the parts illustrated in FIG. 5 and FIG. 16 are identified by the same reference numerals, and description thereof will be omitted. Suppose that in an initial state, the optical connector-to-lens distance 1601 is 300 [μm]. Then, suppose that the optical transmission environment of the optical module 100 is the liquid 1501. The liquid 1501 is a liquid such as Fluorinert or the like for cooling the optical module 100. For example, a rise in temperature due to heat generation of the PD array 111 and the VCSEL array 112 or the like may be suppressed by using the optical module 100 in a state in which the optical module 100 is immersed in the liquid 1501.

The optimum optical connector-to-lens distance 1601 in the case where the optical transmission environment is the liquid 1501 is 250 [μm] (see FIG. 12). The adjusting person therefore decreases the amounts of projection of the pins 132a and 132b by rotating the adjusting handles 133a and 133b. Consequently, the optical connector-to-lens distance 1601 is decreased by 50 [μm], so that the optical connector-to-lens distance 1601 may be set at 250 [μm].

For example, the adjusting person makes the adjustments illustrated in FIG. 14 and FIG. 16 in the case where the optical transmission environment of the optical module 100 is air, and makes the adjustments illustrated in FIG. 15 and FIG. 17 in the case where the optical transmission environment of the optical module 100 is the liquid 1501. Thus, an optical loss may be reduced by adjusting the optical element-to-lens distance 1401 and the optical connector-to-lens distance 1601 according to the optical transmission environment of the optical module 100.

(Another Example of Part of Optical Module According to Embodiment)

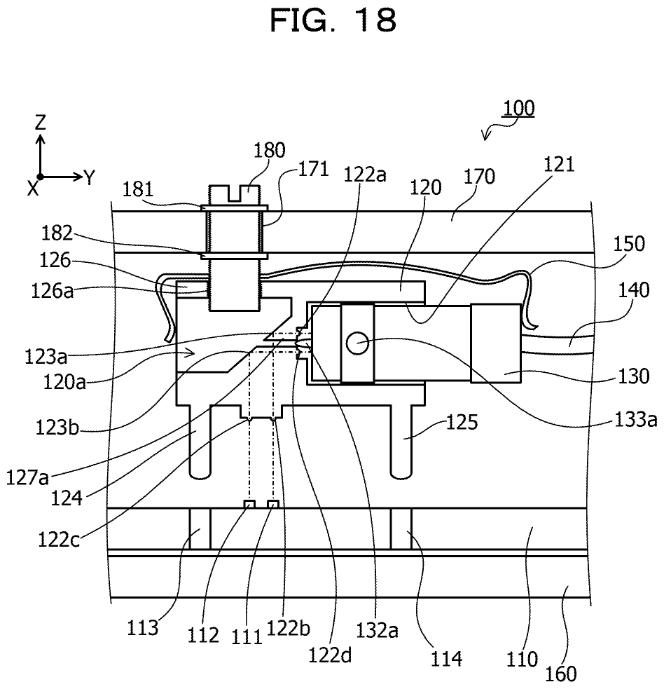

FIG. 18 is a partially transparent side view illustrating another example of a part of an optical module according to the embodiment. In FIG. 18, parts similar to the parts illustrated in FIG. 1 are identified by the same reference numerals, and description thereof will be omitted. As illustrated in FIG. 18, a configuration may be adopted in which the screw groove to be fitted with the fine thread screw 180 is not provided to the through hole 171 of the upper surface side cover 170, but a screw groove to be fitted with the fine thread screw 180 is provided to the through hole 126a of the lens block 120.

In this case, the E-rings 181 and 182 are configured to sandwich the periphery of the through hole 171 of the upper surface side cover 170 in the Z-axis direction. The relative position of the fine thread screw 180 in the Z-axis direction with respect to the upper surface side cover 170 is thereby fixed. On the other hand, the fine thread screw 180 is freely rotatable about the Z-axis direction with respect to the lens block 120.

For example, when the fine thread screw 180 is rotated about the Z-axis direction, the relative position of the fine thread screw 180 with respect to the lens block 120 in the Z-axis direction is changed, but the relative position of the fine thread screw 180 with respect to the upper surface side cover 170 is not changed. Consequently, as in the above-described configuration, the optical element-to-lens distance may be adjusted.

Thus, the optical module 100 according to the embodiment includes the fine thread screw 180 disposed so as to pass through the through hole 171 disposed in the upper surface side cover 170 of the casing and the through hole 126a disposed in the lens block 120. When the fine thread screw 180 is rotated, the fine thread screw 180 changes a distance between the upper surface side cover 170 and the lens block 120.

It is thereby possible to adjust a distance between optical elements (the PD array 111 and the VCSEL array 112) on the PCB 110 fixed to the lower surface side cover 160 of the casing and the lens block 120. An optical loss may therefore be reduced by adjusting the distance between the optical elements and the lens block 120 according to the index of refraction of the environment in which the optical module 100 is used. In addition, it is possible to correct variations in the distance between the optical elements and the lens block 120 due to variations at a time of manufacturing.

For example, a screw groove to be fitted with the fine thread screw 180 is formed on the inside of one of the through holes 171 and 126a. In addition, a screw groove to be fitted with the fine thread screw 180 is not formed on the inside of the other of the through holes 171 and 126a, and the relative position of the other of the through holes 171 and 126a with respect to the fine thread screw 180 in the axial direction (Z-axis direction) of the fine thread screw 180 is fixed by the E-rings 181 and 182 (retaining rings) or the like. Thus, when the fine thread screw 180 is rotated, the fine thread screw 180 may change the distance between the upper surface side cover 170 and the lens block 120.

In addition, the optical module 100 includes the guide pins 124 and 125 arranged on the lens block 120 and the guide holes 113 and 114 arranged in the PCB 110 and having shapes corresponding to the guide pins 124 and 125. When the guide pins 124 and 125 and the guide holes 113 and 114 are fitted to each other, the relative position of the lens block 120 with respect to the PCB 110 is fixed in directions (the X-axis direction and the Y-axis direction) orthogonal to the traveling direction of light between the lens block 120 and the optical elements. It is thereby possible to adjust the distance between the optical elements and the lens block 120 while suppressing a displacement of optical axes between the optical elements and the lens block 120.

However, the configuration related to the guide pins 124 and 125 and the guide holes 113 and 114 is not limited to this. For example, a configuration may be adopted in which the guide pins 124 and 125 are provided to the PCB 110, and the guide holes 113 and 114 are provided to the lens block 120. This configuration also makes it possible to adjust the distance between the optical elements and the lens block 120 while suppressing a displacement of the optical axes between the optical elements and the lens block 120.

In addition, the optical connector 130 includes the pins 132a and 132b (projections) that project from the end surface on the side of the lens block 120 and which have front ends thereof abutting against the lens block 120. The optical connector 130 also includes the adjusting handles 133a and 133b (adjusting parts) that change the distance between the optical connector 130 and the lens block 120 by adjusting the amounts of projection of the pins 132a and 132b. It is thereby possible to adjust the distance between the lens block 120 and the optical connector 130. An optical loss may therefore be reduced by adjusting the distance between the lens block 120 and the optical connector 130 according to the index of refraction of the environment in which the optical module 100 is used. In addition, it is possible to correct variations in the distance between the lens block 120 and the optical connector 130 due to variations at a time of manufacturing.

Incidentally, in the foregoing embodiment, description has been made of a configuration in which the PD array 111 and the VCSEL array 112 are arranged on the PCB 110. However, a configuration may be adopted in which one of the PD array 111 and the VCSEL array 112 is disposed on the PCB 110. In addition, while description has been made of a configuration in which the PD array 111 is disposed on the PCB 110, a configuration may be adopted in which a single PD is disposed on the PCB 110. In addition, while description has been made of a configuration in which the VCSEL array 112 is disposed on the PCB 110, a configuration may be adopted in which a single LD is disposed on the PCB 110.

As described above, according to the optical module, it is possible to adjust the distance between the optical elements and the lens block.

For example, in a field of servers, high-end computers, and the like, the transmission capacity of an input/output (I/O) (photoelectric) unit for performing communication between CPUs and an external interface has been increasing due to improvements in performance as a result of introduction of multi-CPU systems. CPU is an abbreviation of Central Processing Unit. For example, photoelectric conversion elements are arranged on a substrate, and an optical connector (MT) is directly connected to the photoelectric conversion elements. High-capacity high-speed transmission by light is thereby realized.

In addition, as high-density mounting and ultra-high speed are achieved, heat generated from the elements becomes a problem. As a solution for the problem, there is a method of cooling an optical module by immersing the optical module in a liquid. However, at an optical coupling part of the optical module, the transmission characteristics of light are changed by a variation in index of refraction due to the liquid or the like. It is therefore difficult to achieve the immersion.

On the other hand, according to the foregoing embodiment, it is possible to adjust the optical connector-to-lens distance, and besides, to adjust the optical element-to-lens distance according to the optical transmission environment of the optical module. For example, an optical loss may be suppressed by adjusting the optical connector-to-lens distance and the optical element-to-lens distance according to whether the optical module is used in air or used in a liquid. The same optical module may therefore be used in a plurality of different optical transmission environments.

In addition, even in a case where the optical module is not used in a plurality of different optical transmission environments, it is possible to correct variations in the optical connector-to-lens distance and the optical element-to-lens distance due to mounting variations of the lens block, fitting variations of the optical connector, and the like.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical module comprising:
a casing;
a substrate fixed to a first surface of the casing, the first surface is included in an inside of the casing;
an optical element disposed on the substrate and includes at least one of a light receiving element and a light emitting element;
a lens block disposed on the inside of the casing, and optically couples an optical connector coupled to an optical transmission line and the optical element to each other; and
a male screw disposed so as to pass through a hole disposed in a second surface of the casing, the second surface being opposite from the first surface, and a hole disposed in the lens block, and changes a distance between the second surface and the lens block when the male screw is rotated.

2. The optical module according to claim 1, wherein
the optical element includes the light receiving element,
the optical connector emits light passed through the optical transmission line to the lens block, and
the lens block condenses the light emitted from the optical connector onto the light receiving element.

3. The optical module according to claim 2, wherein
the lens block emits the light emitted from the optical connector in a direction parallel with the substrate to the light receiving element in a direction orthogonal to the substrate.

4. The optical module according to claim 1, wherein
the optical element includes the light emitting element,
the lens block condenses light emitted from the light emitting element to the optical connector, and
the optical connector emits the light emitted from the lens block to the optical transmission line.

5. The optical module according to claim 4, wherein
the lens block emits the light emitted from the light emitting element in a direction orthogonal to the substrate to the optical connector in a direction parallel with the substrate.

6. The optical module according to claim 1, wherein
a screw groove to be fitted with the male screw is formed on an inside of one of the hole disposed in the second surface of the casing and the hole disposed in the lens block, and
no screw groove is formed on an inside of an other of the hole disposed in the second surface of the casing and the hole disposed in the lens block, and the other of the hole disposed in the second surface of the casing and the hole disposed in the lens block has a fixed relative position with respect to the male screw in an axial direction of the male screw.

7. The optical module according to claim 5, wherein
a relative position of an other of the hole disposed in the second surface of the casing and the hole disposed in the lens block with respect to the male screw in an axial direction of the male screw is fixed by a retaining ring disposed on the male screw.

8. The optical module according to claim 1, wherein
a relative position of the lens block with respect to the substrate is fixed in a direction orthogonal to a traveling direction of light between the lens block and the optical element by fitting a guide pin and a guide hole to each other, the guide pin being disposed on one of the lens block and the substrate, and the guide hole being disposed in an other of the lens block and the substrate and having a shape corresponding to the guide pin.

9. The optical module according to claim 1, wherein
the optical connector includes a projection projecting from an end surface of the optical connector, the end surface being on a side of the lens block, and having a front end abutting against the lens block, and an adjusting part that changes a distance between the optical connector and the lens block by adjusting an amount of projection of the projection from the end surface.
